(19) United States
(12) Patent Application Publication
(10) Pub. No.: US 2024/0056782 A1
(43) Pub. Date: Feb. 15, 2024

(54) RF-BASED SENSING USING RSSI AND CSI

(71) Applicant: SIGNIFY HOLDING B.V., EINDHOVEN (NL)

(72) Inventors: PETER DEIXLER, ARLINGTON, MA (US); HUGO JOSÉ KRAJNC, EINDHOVEN (NL)

(21) Appl. No.: 18/271,071

(22) PCT Filed: Dec. 22, 2021
(86) PCT No.: PCT/EP2021/087245

§ 371 Date: Jul. 6, 2023

Related U.S. Application Data
(60) Provisional application No. 63/134,637, filed on Jan. 7, 2021.

(30) Foreign Application Priority Data
Jan. 12, 2021 (EP) 21151072.2

(51) Int. Cl. H04W 4/38; H04B 7/06; H04B 17/318

(52) U.S. Cl. CPC H04W 4/38; H04B 7/0626; H04B 17/328

(57) ABSTRACT

The present invention relates to performing radio frequency based sensing based on channel state information (CSI), received signal strength indicator (RSSI), or a combination thereof based on a current context. A current context for performing radio frequency based sensing is determined and at least one of two nodes (26, 28, 30) of a radio frequency system (100) is configured for performing radio frequency based sensing based on CSI, RSSI, or a combination thereof based on the current context. The current context may be determined in real time. This may allow improving detection performance and/or reducing energy consumption in real time.

### FIELD OF THE INVENTION

The present invention relates to a radio frequency (RF) system for performing RF-based sensing, a method for performing RF-based sensing, and a computer program product.

### BACKGROUND OF THE INVENTION

WO 2019/096784 A1 shows a method to detect an intruder to a wireless network formed at least partially by a plurality of luminaires connected in wireless communication. The method includes the steps of: monitoring, by network interfaces of each of the plurality of luminaires in a connected lighting system, wireless network activity of a plurality of client devices; receiving, by the network interfaces of each of the luminaires, one or more physical layer characteristics from each of the client devices that is accessing the wireless network and is located within a geographic area defined by a communication range of each luminaire over a designated time interval; retrieving, by a processor of the connected lighting system, an array of reference distributions, the array including a subset of reference distributions for each luminaire, each subset including a plurality of the reference distributions respectively corresponding to a plurality of time intervals, each reference distribution representing an expected distribution of the one or more physical layer characteristics for a corresponding one of the luminaires during a corresponding one of the time intervals from the plurality of time intervals; generating, by the processor of the connected lighting system, an observed distribution for each of the luminaires, each observed distribution representing an actual distribution of values of the one or more physical layer characteristics received by a given one of the luminaires over the designated time interval; comparing, by the processor of the connected lighting system, each observed distribution to one of the reference distributions corresponding to the designated time interval in order to detect an anomaly; and initiating, by the processor of the connected lighting system, an alarm status if the anomaly is detected. According to one embodiment, the physical layer characteristics include Received Signal Strength Indicator (RSSI), Channel State Information (CSI), or a combination including at least one of the foregoing.

WO 2020/043592A1 discloses a system for selecting one or more devices in a wireless network for transmitting, receiving and/or processing a radio frequency signal for presence and/or location detection comprising at least one processor configured to determine a suitability of each of a plurality of devices for transmitting, receiving and/or processing a radio frequency signal for presence and/or location detection, select a subset of devices from the plurality of devices based on the suitability determined for each of the plurality of devices, and instruct at least one of the subset of devices to act as a device for transmitting, receiving and/or processing a radio frequency signal for presence and/or location detection.

### SUMMARY OF THE INVENTION

It can be seen as an object of the present invention to provide an RF system, a method for performing RF-based sensing, a computer program product, and a computer readable medium which allow improving detection performance and/or reducing energy consumption for performing RF-based sensing.

In a first aspect of the present invention an RF system comprising at least two nodes for performing RF-based sensing in a sensing area is presented. The RF system is configured for determining a current context for performing RF-based sensing and for configuring at least one of the nodes for performing RF-based sensing based on CSI, RSSI, or a combination thereof based on the current context.

Since the RF system is configured for configuring at least one of the nodes for performing RF-based sensing based on CSI, RSSI, or a combination thereof based on the current context, detection performance for performing RF-based sensing may be improved and/or energy consumption may be reduced. The RF system may be configured for determining the current context in real time. This allows adapting the RF-based sensing performed by the RF system in real time in view of the current context.

In general, performing RF-based sensing based on CSI, i.e., CSI-based sensing, provides more details than performing RF-based sensing based on RSSI, i.e., RSSI-based sensing. Under certain circumstances, i.e., based on the current context, RSSI-based sensing may be beneficial compared to CSI-based sensing. RSSI-based sensing may be beneficial compared to CSI-based sensing, for example, either due to sensing application limitations, such as standby power requirements or due to environmental circumstances, such as degraded signal-to-noise (SNR) ratio caused by too long distance transmission or interference. The RF system may allow to determine in real time based on the current context whether it is beneficial to perform RF-based sensing based on CSI or RSSI, or a combination thereof, e.g., throughout the sensing area, such as a room or space of a building.

The RF system may be configured for performing RF-based sensing based on RSSI, CSI, or a combination thereof. The RF system may perform RF-based sensing based on RSSI, CSI, or a combination thereof based on how the at least one of the nodes is configured based on the current context.

RF-based sensing allows for the detection of various sensing events taking place in a sensing area, i.e., a specific space or specific volume, such as a room in a building, a building, or any other space. Sensing algorithms or sensing analysis algorithms may detect and analyse how tangible entities within the sensing area affect RF signals. RF signals are used for transmitting RF messages. RF-based sensing may be used as means for detecting and classifying sensing events, such as user activity in homes, offices, etc. For example, based on WiFi RF-based sensing messages being transmitted and received by nodes in form of smart lights, RF-based sensing may determine motion in a room and turn lights on or off automatically, nodes in form of WiFi routers may estimate breathing rate of people, etc.

The underlying principle for RF-based sensing is that distortions of RF signals in a space are both a function of the tangible entities in it, e.g., moving objects, as well as of the frequency of the RF signals. Radio waves are propagated through electromagnetic radiation and interact with an environment by reflection, refraction, diffraction, absorption, polarization, and scattering. Wireless attenuation is different for different materials within a typical frequency range used by RF-based sensing applications. Therefore, characteristics of the sensing area, e.g., a construction form of a room, a spatial arrangement, and integral-surface-area of each material type present in the sensing area may influence RF multipath signal characteristics of the sensing area.

For performing RF-based sensing, one node may act as a transmitting node transmitting RF signals including RF messages to another node acting as a receiving node. The received RF signals may then be analysed. If the RF signals interact with one or more tangible entities, e.g., objects or persons, on their transmission paths between the nodes, the RF signals are disturbed, such as scattered, absorbed, reflected, or any combination thereof. These disturbances can be analysed and used for performing RF-based sensing. The disturbed and/or reflected RF signals can include an RF-based sensing fingerprint based on signal parameters, such as real and imaginary part of electrical permittivity and magnetic susceptibility.

Both RSSI and CSI are metrics that are extracted from an RF message transmitted on an RF channel and therefore are a function of the RF message. RSSI is a measurement of an overall attenuation of a wireless communication link between two nodes. In other words, RSSI is a coarse measurement of an amount of power the node estimates when it starts receiving an RF message, i.e., RSSI corresponds to an average amount of power of the RF message. CSI, e.g., WiFi CSI represents how RF signals propagate in an RF channel between the transmitting node and the receiving node at certain carrier frequencies along multiple spatial paths and which represents an impact a tangible entity has along different frequencies. In other words, CSI is a metric which is extracted from subcarriers used to modulate and demodulate an RF message, e.g., a WiFi message. These subcarriers represent different parts of the spectrum of the RF channel itself resulting in more data points per RF message than with RSSI. CSI captures RF characteristics of nearby environment, as CSI's amplitude and phase are impacted by multi-path effects including amplitude attenuation and phase shift of the RF signals. For an RF system with multiple input multiple output orthogonal frequency-division multiplexing (MIMO-OFDM), the CSI measurement provides a three-dimensional (3D) matrix of complex values representing the amplitude attenuation and phase shift.

A time-series of multiple CSI measurements captures how RF signals travel through surrounding tangible entities, such as physical objects and humans, in time, frequency, and spatial domains. Transmitting RF signals through an RF multipath channel and using analysis algorithms, such as artificial intelligence analysis algorithms, for analysing the time-series of multiple CSI measurements may enable a wide range of different wireless sensing applications. For example, CSI amplitude variations in the time domain may have different patterns for different humans, activities, gestures, or the like, which may be used for human presence detection, motion detection, activity recognition, gesture recognition, and human identification.

Observed CSI phase shifts in spatial and frequency domains, i.e., transmit/receive antennas and carrier frequencies, are related to signal transmission delay and arrival direction, which may be used for leveraging RF-based sensing—in addition to occupancy and activity detection—also for human localization and tracking across the sensing area, e.g., a building space.

CSI phase-shifts in time domain may have different dominant frequency components which, for instance, may be used to estimate a breathing rate when performing RF-based sensing based on CSI, i.e., CSI-based sensing.

As both CSI-based sensing, i.e., performing RF-based sensing based on CSI, and RSSI-based sensing, i.e., performing RF-based sensing based on RSSI, may rely on a same physical radio, e.g., if both are extracted from the same protocol, such as WiFi, and as the same RF messages may be analysed for both to probe the sensing area, the physics of signal-propagation of the two RF-based sensing methods may be identical, i.e., the RF multipath channel within the sensing area does not change just because either CSI data or RSSI data is extracted from the radio.

In addition, both RSSI-based sensing and CSI-based sensing analyses the time series of the RF channel between the two nodes. Compared to an RSSI-based sensing algorithm, a CSI-based sensing algorithm may extract metrics from each of different WiFi subcarriers which may be related to the multipath characteristics of the sensing area, e.g., physical building space.

CSI amplitude and phase are impacted by RF signals from multiple paths within the sensing area rather than a single RF path. For example, RSSI is a simple measurement natively performed by any RF radio for ‘house-keeping’ purposes. In contrast, for performing CSI-based sensing using WiFi, multipath information has to be first derived from measured raw CSI data as provided by a WiFi microcontroller. For instance, a 20 MHz WiFi channel may have 64 CSI subcarrier frequencies. Since each of these sub-frequencies interact different with tangible entities, such as material objects, e.g. a brick wall of a room or upholstery of a couch, the analysis of how the 64 subcomponents integrally behave, e.g. their relative differences, may be indicative of multipath behaviour of the sensing area.

The current context may include one or more of:
a sensing application,
a latency requirement,
a radio power consumption requirement,
a radio transmit power requirement,
a radio beam shape requirement,
a radio receive beamforming requirement,
a current location of the radio frequency system,
a current location of the at least one of the nodes,
a current date,
a current operation mode of the at least one of the nodes,
environmental effects,
currently available bandwidth in the RF system,
current capabilities of the at least one of the nodes,
current properties of the sensing area,
a false event detection rate requirement, and
a growth stage of a plant in the sensing area.

The sensing application may include, for example, which type of sensing event is to be detected by performing RF-based sensing, such as a snappy, low-latency motion detection, occupancy detection, vacancy detection, fall detection, heartbeat detection, or any other sensing event. The RF system may be configured for performing RSSI-based sensing, for example, if the sensing application is a motion or presence detection sensing application for detecting motion or presence of a tangible entity, such as a user. RSSI directly relates to attenuation of the RF signals for performing RF-based sensing. This may allow to obtain an increased SNR as all transmission paths between the transmitting node and the receiving node of the RF signals are included in a transmission channel. This may allow transmitting with lower transmission power by the transmitting node. Furthermore, RSSI-based sensing may be performed with lower energy consumption of the nodes compared to performing CSI-based sensing.

The RF system may also be configured for performing RSSI-based sensing, for example, if the sensing application is a life-safety-critical sensing application. The RF system may be configured for performing CSI-based sensing, for example, if the sensing application is vacancy detection and light shall be automatically turned off when vacant. This may allow detecting details when the sensing area becomes occupied, e.g., allowing improved people counting and classification. The RF system may be configured to perform RSSI-based sensing after obtaining this context information for lowering energy consumption.

The sensing application may also provide context by including requirements of the sensing application, such as standby-power requirements for the sensing application, e.g., a currently required standby-power level.

The RF system may be configured for performing RSSI-based sensing if a low latency is required, e.g., for life-safety-critical sensing applications which require a fast reaction. RSSI-based sensing may allow to detect sensing events faster than CSI-based sensing. Latency requirements, such as lighting control latency requirements, may depend, for example, on a status of the sensing area. The sensing area may be, for example, occupied or vacant. In case that the sensing area is vacant, nodes in form of luminaires may, for example, need to be turned on in less than 200 ms in response to a person entering the sensing area. In order to achieve a latency of less than 200 ms, RSSI-based sensing may be used. If on the other hand higher accuracy is required, e.g., if a room is occupied and certain details need to be determined, CSI-based sensing may be performed. This may allow reducing false negative detections.

The radio power consumption requirement may include, for example, a standby-power regulatory requirement. A standby-mode may include, for example, not performing a primary function of the node. The node, may be configured, for example, to perform RF-based sensing in the standby mode, i.e., when it is not performing its primary function. For example, the node may be a luminaire, which does not provide light in standby-mode, but performs RF-based sensing. In this case, standby power consumed by the node corresponds to power being consumed by the node while processing RF sensing messages, e.g., including receiving the RF sensing messages, and processing them, e.g., using an analysis algorithm. Performing RSSI-based sensing requires less processing effort than performing CSI-based sensing, which may allow reducing energy consumption and fulfilling radio power consumption requirements.

The radio transmit power requirement may include, for example, a limitation of transmit power, e.g., due to wireless interference caused by high transmit power. For example, in a hospital room, medical machines may be disturbed by the wireless interference, such that an allowable RF transmit power for performing RF-based sensing may be limited based on the radio transmit power requirement.

The radio beam shape requirement and the radio receive beamforming requirement relate to how beams are required to be shaped which are used for performing RF-based sensing. Beams may be, for example, narrow beams or divergent beams. The beam shape may influence the sensing area that may be covered by performing RF-based sensing. Narrow beams may, for example, allow to cover a longer sensing area, while divergent beams may, for example, allow to cover a wider sensing area. Using a narrow beam may allow to perform RF-based sensing between two nodes which area farther away from each other compared to using a divergent beam. Furthermore, using a narrow beam allows focusing the RF signal into a specific direction, such that beamforming in this manner may allow to provide higher signal quality to the receiving node.

Requirements, such as standby-power regulatory requirements or radio transmit power requirements may depend, for example, on the current location of the RF system and/or the at least one of the nodes, and/or on the current date, such as a time of the day or day of the week. The current location of the at least one of the nodes may also include, for example, a relative location between the nodes which may influence a length of the transmission between the nodes.

A current operation mode of a respective node may include, for example, performing a primary function, such as providing lighting, performing RF-based sensing, and/or operating in standby-mode.

Environmental effects may include, for example, wireless interference, low SNR, and/or background noise level. The environmental effects may be caused, for example, based on humidity in the air, smog, cigarette smoke, a current state of the sensing area, e.g., being occupied or vacant, or the like. The RF system may be configured for performing CSI-based sensing if a current SNR is above a threshold SNR and RSSI-based sensing if the current SNR is below the threshold SNR. The threshold SNR may be selected, for example, such that it corresponds to a SNR at which CSI-based sensing fails on many subcarriers.

Taking into account the currently available bandwidth in the RF system may allow to compensate a certain degree of lack of sampling rate, e.g., due to missing RF messages. Performing CSI-based sensing may allow to compensate lack of sampling rate in case of low available bandwidth or high background noise levels due to which a lack of sampling rate may occur as CSI may be less prone to noise than RSSI. Background noise may be caused, for example, by a noise source, such as a microwave oven or a streaming television. The background noise may deteriorate the SNR for the RF-based sensing and increase a number of missed RF messages between the nodes, i.e., reducing the sampling rate or effective messaging rate, respectively.

The properties of the sensing area may include, for example, a shape, a regularity, materials, an archetype of a room in which the nodes are arranged or any other property of the sensing area. This allows taking into account the properties of the room for determining whether performing CSI-based sensing, RSSI-based sensing, or a combination thereof is beneficial.

The false event detection rate requirement may include a false positive rate versus a false negative rate.

The RF system may be configured for performing RSSI-based sensing, for example, during growth stages in which plant growth is inferior when RF signals with high transmit power are transmitted in the sensing area. Since RSSI-based sensing may allow performing RF-based sensing with lower transmit power than CSI-based sensing, RSSI-based sensing may be preferred in such growth stages of the plant.

The RF system may be configured for first performing RSSI-based sensing and cascade to CSI-based sensing. The RF system may be configured for using RSSI-based sensing as a trigger for performing CSI-based sensing, i.e., CSI-based sensing may be performed by the RF system upon detecting a sensing event based on RSSI-based sensing. This allows cascading of RSSI-based sensing to CSI-based sensing, which may allow a reduce energy consumption while high level of accuracy may be maintained.

The RF system may be configured for concurrently performing RF-based sensing based on CSI and RSSI. Concurrently performing RF-based sensing based on CSI and RSSI may allow an improved detection performance. The RF system may concurrently perform RF-based sensing by, for example, performing CSI-based sensing by one node and by performing RSSI-based sensing, e.g. using Zigbee or BLE, by another node. Alternatively, a single node may perform RF-based sensing based on CSI and RSSI, e.g., using WiFi. Performing RF-based sensing based on CSI and RSSI by a single node may include interleaving time intervals in which CSI-based sensing is performed and time intervals in which RSSI-based sensing is performed.

The at least two nodes may include a transmitting node, a CSI-receiving node, and an RSSI-receiving node. The CSI-receiving node may be configured for performing RF-based sensing based on CSI, i.e., CSI-based sensing. The RSSI-receiving node may be configured for performing RF-based sensing based on RSSI, i.e., RSSI-based sensing. Performing RF-based sensing by a CSI-receiving node based on CSI and a RSSI-receiving node based on RSSI may allow an improved detection performance. The transmitting node, the CSI-receiving node and the RSSI-receiving node may be arranged in the sensing area and/or define the sensing area. The transmitting node may be configured for transmitting RF messages to the CSI-receiving node and the RSSI-receiving node for performing RF-based sensing.

The transmitting node may be configured for transmitting same RF messages to the CSI-receiving node and the RSSI-receiving node for performing RF-based sensing. This may allow to concurrently perform RF-based sensing by CSI-receiving nodes and RSSI-receiving nodes and to improve detection performance and/or reduce energy consumption of the RF system. The transmitting node may be configured for transmitting the RF messages such that the RF messages are receivable and processable by both the CSI-receiving node and the RSSI-receiving node. The RF messages may be, for example, WiFi RF messages.

The sensing area may be predefined or formed by the nodes, e.g., defined based on locations of the nodes.

The transmitting node may be configured for transmitting and receiving the same RF messages transmitted to the CSI-receiving node and the RSSI-receiving node for performing RF-based sensing by the transmitting node. This may allow for performing RF-based Doppler sensing by the transmitting node. The transmitting node may comprise a transceiver unit and antennas configured for transmitting the same RF messages to the CSI-receiving node and the RSSI-receiving node and for receiving the same RF messages for performing RF-based sensing by the transmitting node. The RF-based sensing performed by the transmitting node may be, for example, RF-based Doppler sensing which listens to echoes in the sensing area, i.e., reflected RF messages are received and analysed by the transmitting node. The transmitting node may perform RF-based Doppler sensing by analysing a combination of Doppler and micro Doppler shifts of the reflected RF messages generated by a complex object with micro Doppler shifts generated by different elements of the complex object, for example, a human body including different elements, such as a torso, legs, and arms. The Doppler effect may be visualized in a heatmap whereas an x-axis shows a speed of movement and a y-axis may indicate a distance between an object causing the echo and the transmitting node.

The CSI-receiving node may be configured for performing CSI-based sensing in a CSI sensing area. The RSSI-receiving node may be configured for performing RSSI-based sensing in an RSSI sensing area. The CSI sensing area and the RSSI sensing area may be included in the sensing area. At least part of the CSI sensing area may overlap with the RSSI sensing area in an overlap sensing area. Performing RF-based sensing by the CSI-receiving node and the RSSI-receiving node in an overlap sensing area may allow to obtain more details and improve RF-based sensing.

The RSSI-receiving node may be selected from the at least two nodes for performing RF-based sensing in the sensing area such that the overlap sensing area is maximized and/or an area of interest is within the overlap area. Alternatively, or additionally, the CSI-receiving node may be selected from the at least two nodes for performing RF-based sensing in the sensing area such that the overlap sensing area is maximized and/or an area of interest is within the overlap area. Alternatively, or additionally, the RSSI-receiving node and the CSI-receiving node may be selected from the at least two nodes for performing RF-based sensing in the sensing area such that the overlap sensing area is maximized and/or an area of interest is within the overlap area, i.e., such that the overlap sensing area is maximized, such that an area of interest is within the overlap area, or such that the overlap sensing area is maximized and the area of interest is within the overlap area. Selecting the RSSI-receiving node and/or the CSI-receiving node from the at least two nodes for performing RF-based sensing in the sensing area such that the overlap sensing area is maximized may allow to optimize use of nodes with different capabilities. Selecting the RSSI-receiving node and/or the CSI-receiving node from the at least two nodes for performing RF-based sensing in the sensing area such that an area of interest is within the overlap area may allow to improve detection performance and accuracy in area of interest by using both RSSI and CSI.

The RF system may include a CSI group of nodes performing RF-based sensing based on CSI. The CSI-receiving node may be included in the CSI group. Alternatively, or additionally, the RF system may include an RSSI group of nodes performing RF-based sensing based on RSSI. The RSSI-receiving node may be included in the RSSI group.

The CSI group and/or the RSSI group may be formed based on the current context, for example, based on capabilities and/or locations of the nodes. The current context may additionally or alternatively include current environmental effects, e.g., there may be a too low SNR for performing CSI-based sensing by certain nodes, such that these nodes may perform RSSI-based sensing.

The RF system may be configured for performing RSSI-based sensing for motion or occupancy detection. This may allow transmitting RF messages with a reduced transmission power compared to performing CSI-based sensing. The RF system may be configured for transmitting the RF messages with a reduced transmission power when performing RSSI-based sensing compared to performing CSI-based sensing.

The RF system may be configured for determining one or more properties of the sensing area based on performing RSSI-based sensing and/or CSI-based sensing. The RF system may be configured for analysing a degree of difference between results obtained from performing RSSI-based sensing and CSI-based sensing in order to determine the one or more properties of the sensing area. This may allow to improve determination of, for example, whether the sensing area is larger or smaller, whether objects are in the sensing area, or the like. The RF system may be configured for utilizing predetermined sensing area classifications, e.g., based on fingerprints of the sensing areas. The sensing area classifications may include, for example, a larger sensing area, a smaller sensing area, an open space, a closed space, a kitchen, a living room, or the like.

The RF system may be configured for performing RF-based sensing for monitoring growth of a plant. Monitoring growth of the plant may include, for example, monitoring a change of biomass of leaves, and/or monitoring change of roots, such as an architecture of the roots, e.g., in a growing medium such as rockwool. Alternatively, or additionally, monitoring growth of the plant may include monitoring a wetness of leaves, e.g., due to unwanted condensation, and/or environmental conditions in proximity of the plant, for example, mm-wave RF-based sensing may be used for inferring humidity. The RF system may be configured for performing CSI-based sensing, RSSI-based sensing, or a combination thereof such that a negative impact on growth of the plant is minimized. The plant may be, for example, a soybean plant. The RF system may be used, for example, in vertical farming. The RF system may be configured for selecting to perform CSI-based sensing or RSSI-based sensing in dependence of the growth stage of the plant. For example, lower transmit power may be used by RSSI-based sensing, which may yield plant health benefits. The RF system may be configured, for example, to select CSI-based sensing or RSSI-based sensing for performing the RF-based sensing in dependence of a relative location of the node to the plant.

The at least two of the nodes may have different capabilities. Different capabilities may include different transmitting capabilities, different receiving capabilities, different processing capabilities, or a combination thereof. For example, one of the nodes may be of different type, older than the other node, damaged, or the like. The RSSI-receiving node may be configured, for example, for performing RF-based sensing only based on RSSI, e.g., it may be only capable to receive RF messages in the 2.4 GHz without OFDM.

In a further aspect of the present invention a method for performing RF-based sensing in a sensing area by at least two nodes is presented. The method comprises the steps:
determining a current context for performing radio frequency based sensing, and
configuring at least one of the nodes for performing radio frequency based sensing based on CSI, RSSI, or a combination thereof based on the current context.

The method may include one or more of the steps:
concurrently performing radio frequency based sensing based on CSI and RSSI,
transmitting by a transmitting node same radio frequency messages to a CSI-receiving node for performing radio frequency based sensing based on CSI and a RSSI-receiving node for performing radio frequency based sensing based on RSSI,
transmitting and receiving by the transmitting node the same radio frequency messages transmitted to the CSI-receiving node and the RSSI-receiving node for performing radio frequency based sensing by the transmitting node,
performing radio frequency based sensing in a CSI sensing area, wherein the CSI sensing area is included in the sensing area,
performing radio frequency based sensing in a RSSI sensing area, wherein the RSSI sensing area is included in the sensing area,
providing that at least part of the CSI sensing area overlaps with the RSSI sensing area in an overlap sensing area,
providing that the overlap sensing area is maximized,
providing that an area of interest is within the overlap area,
determining one or more properties of the sensing area based on performing radio frequency based sensing based on RSSI and/or CSI, and
performing radio frequency based sensing for monitoring growth of a plant.

In a further aspect of the present invention a computer program product for performing RF-based sensing in a sensing area by at least two nodes is presented. The computer program product comprises program code means for causing a processor to carry out the method according to claim 12, claim 13, or any embodiment of the method, when the computer program product is run on the processor.

In a further aspect a computer readable medium having stored the computer program product of claim 14 is presented. Alternatively, or additionally, the computer readable medium may have the computer program product according to any embodiment of the computer program product stored.

It shall be understood that the RF system of claim 1, the method of claim 12, the computer program product of claim 14, and the computer readable medium of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a node for an RF system,

FIG. 2 shows schematically and exemplarily a first embodiment of an RF system with three nodes that concurrently perform RF-based sensing based on CSI and RSSI,

FIG. 3 shows schematically and exemplarily a second embodiment of an RF system with two nodes that perform RF-based sensing based on CSI or RSSI based on a growth stage of a plant, and

FIG. 4 shows an embodiment of a method for performing RF-based sensing.

### DETAILED DESCRIPTION OF EMBODIMENTS

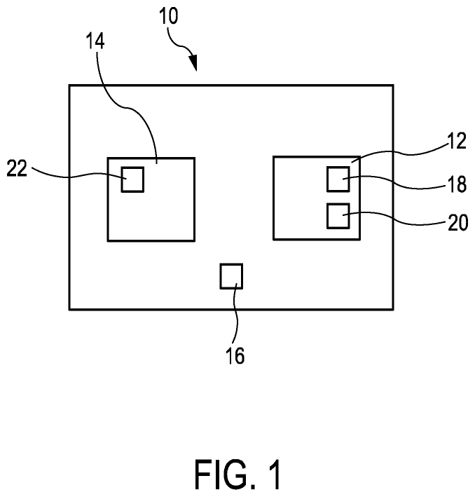

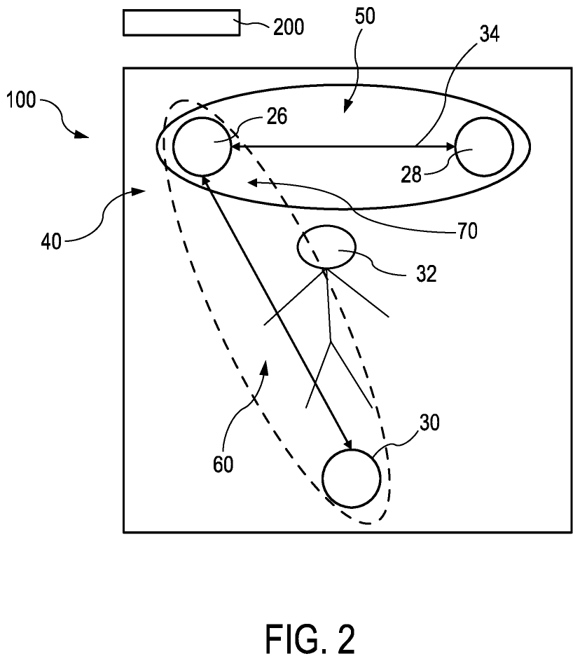

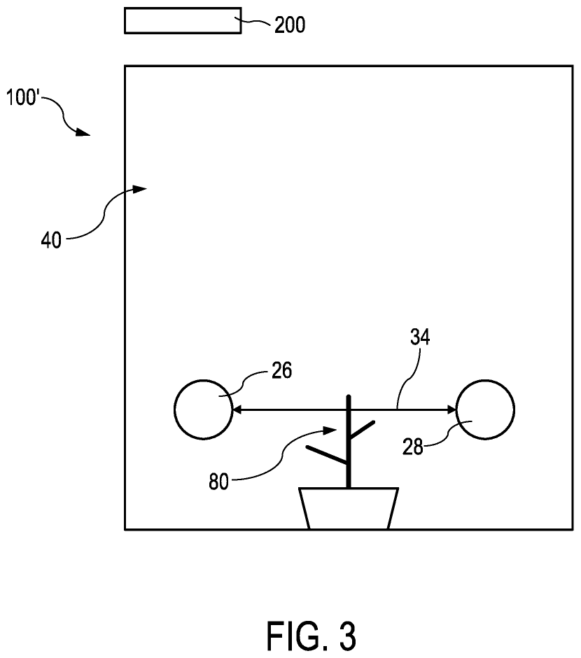

FIG. 1 shows schematically and exemplarily a node for an RF system, e.g., connected lighting (CL) system 100 or 100′ presented in FIG. 2 and FIG. 3, respectively. In the following we describe details for the exemplary node 10 that may be used in the CL system 100 or 100′ before providing details about the functionality of the CL systems 100 and 100′.

The node 10 comprises a control unit 12, a transceiver unit 14, and an antenna array 16. Instead of an antenna array, a single antenna may also be included in the node.

The control unit 12 includes a processor 18 and a computer readable medium in form of memory 20.

In this embodiment, the transceiver unit 14 includes a WiFi transceiver 22 for transmitting and receiving RF signals including RF messages based on WiFi, i.e., WiFi RF messages. In other embodiments, the transceiver unit may also exchange data based on one or more other communication protocols, such as Thread, cellular radio, Bluetooth, or Bluetooth Low Energy (BLE), or any other communication protocol. The transceiver unit may also include two or more transceivers configured for exchanging data based on different communication protocols.

The transceiver unit 14 uses the antenna array 16 for transmitting RF signals to nodes and receiving RF signals from nodes of the CL system 100 or 100′, respectively, for exchanging data including RF messages wirelessly between the nodes and for performing RF-based sensing. The RF signals transmitted from one node to another node may be disturbed, e.g., by a tangible entity such as a user within a transmission path between the nodes. The RF signals disturbed by the user can be analysed in the control unit 12 for performing RF-based sensing.

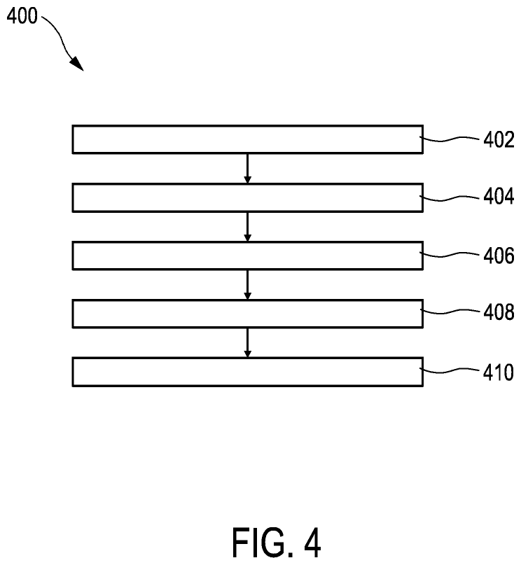

The memory 20 of the control unit 12 stores a computer program product for operating the CL system 100 or 100′, respectively. The computer program product includes program code means for causing processor 18 to carry out a method for operating the CL system 100 or CL system 100′, respectively, when the computer program product is run on the processor 18, e.g., the method for performing RF-based sensing in the sensing area by two nodes as presented in FIG. 4. The memory 20 further includes a computer program product for operating the node 10 and optionally also the whole CL system 100 or 100′, respectively, e.g., for controlling the functions of the node and controlling the functions of the nodes of the CL system 100 or 100′, for example, in order to provide lighting as well as for performing RF-based sensing.

FIG. 2 shows an embodiment of an RF system in form of CL system 100 including three nodes 26, 28, and 30 for performing RF-based sensing. In other embodiments, the RF system may have a different number of nodes, e.g., two, four, or more.

Node 26 is a WiFi router and nodes 28 and 30 are luminaires for providing light as well as for performing RF-based sensing. In other embodiments, the nodes may also be of another type and perform another function, such as switches, lights, bridges, or the like. The node 26 is connected to an external server 200. The external server 200 can be used for controlling the nodes 26, 28, 30 of the CL system 100, e.g., by transmitting control signals to one or more of them. The external server may be, for example, a server of a building management system (BMS). In this embodiment, the external server 200 only exchanges data directly with node 26. Node 26 then may exchange data with the other nodes 28 and 30 for controlling their functions.

In this embodiment, locations of the nodes 26, 28, and 30 define a sensing area 40 in which RF-based sensing is performed by the CL system 100. Furthermore, the locations of the nodes 26 and 28 define a CSI-sensing area 50 in which CSI-based sensing is performed, and the locations of the nodes 26 and 30 define an RSSI-sensing area 60 in which RSSI-based sensing is performed. An overlap sensing area 70 is formed by an overlap of the CSI-sensing area 50 and the RSSI-sensing area 60. In other embodiments, the sensing areas may be predefined.

The CL system 100 is used for performing RF-based sensing based on CSI, RSSI, or a combination thereof based on a current context in the sensing area 40. In the following the functionality of the CL system 100 is explained.

The node 26 of the CL system 100 determines the current context for performing RF-based sensing and configures the nodes 26, 28, and 30 for performing RF-based sensing based on the current context. In this embodiment, the current context includes the sensing application, current locations of the nodes 26, 28, and 30, as well as current capabilities of the nodes 26, 28, and 30. In other embodiments, the current context may further include, for example, a latency requirement, a radio power consumption requirement, a radio transmit power requirement, a radio beam shape requirement, a radio receive beamforming requirement, a current location of the RF system, a current date, environmental effects, a current operation mode of at least one of the nodes, currently available bandwidth in the RF system, current properties of the sensing area, and a false event detection rate requirement.

The sensing application is determined based on a sensing event that is to be detected or sensing events that are to be detected by performing RF-based sensing. The current location of the nodes 26, 28, and 30 may be determined based on time-of-flight (TOF) measurements between the nodes 26, 28, and 30. The current capabilities of the nodes depend on their type, age, and other properties of the nodes. In this embodiment, the nodes 26, 28, and 30 have different capabilities. The node 30 is limited in its processing capabilities in that it can only perform RSSI-based sensing and is not capable of performing CSI-based sensing. Node 26 and 28 may perform CSI-based sensing and/or RSSI-based sensing.

The CL system 100 configures node 28 as a CSI-receiving node for performing CSI-based sensing and node 30 as an RSSI-receiving node for performing RSSI-based sensing. In other embodiments, also other configurations are possible, e.g., both nodes being configured as CSI-receiving nodes or RSSI-receiving nodes.

The CL system 100 then concurrently performs RF-based sensing based on CSI and RSSI, namely, by performing CSI-based sensing by node 28 and by performing RSSI-based sensing by node 30.

Therefore, node 26 acts as a transmitting node that transmits same RF messages 34, i.e., WiFi RF messages, to the CSI-receiving node 28 and the RSSI-receiving node 30 for performing RF-based sensing. In other embodiments, the transmitting node may be configured for transmitting and receiving the same RF messages transmitted to the CSI-receiving node and the RSSI-receiving node for performing RF-based sensing by the transmitting node.

In this embodiment, the CSI-receiving node 28 performs CSI-based sensing in the CSI sensing area 50 and the RSSI-receiving node 30 performs RSSI-based sensing in the RSSI sensing area 60. The CSI sensing area 50 and the RSSI sensing area 60 overlap partly in overlap sensing area 70. The overlap sensing area 70 allows obtaining CSI-data and RSSI-data by performing RF-based sensing and may further improve detection performance. Therefore, it may be beneficial for providing the nodes such that an area of interest is within the overlap area and/or such that the overlap area is maximized, e.g., by changing relative locations of the nodes to each other.

In other embodiments, the RSSI-receiving node and/or the CSI-receiving node may be selected from multiple nodes of the RF system for performing RF-based sensing in the sensing area such that the overlap sensing area is maximized and/or an area of interest is within the overlap area.

In yet other embodiments, the RF system may be configured for determining one or more properties of the sensing area based on performing RF-based sensing based on RSSI and/or CSI.

FIG. 3 shows a second embodiment of an RF system in form of CL system 100′. The CL system 100′ has a similar functionality as the CL system 100 in that it determines a current context and performs RF-based sensing based on CSI, RSSI, or a combination thereof based on the current context.

In contrast to the first embodiment of the CL system 100, the CL system 100′ performs RF-based sensing for monitoring growth of a plant 80 in sensing area 40. In this embodiment, the current context includes a growth stage of the plant 80 in the sensing area 40, i.e., the decision whether CSI-based sensing, RSSI-based sensing, or a combination thereof is performed takes into account a current growth stage of the plant 80.

The CL system 100′ includes multiple nodes, of which two nodes 26 and 28 are shown. Node 26 is a WiFi router and node 28 is a luminaire for providing lighting. Depending on a growth stage, nodes 26 and 28 perform RF-based sensing based on CSI, RSSI, or a combination thereof in order to avoid negative health issues of the plant during growth.

Further embodiments are presented in the following without figures.

In a further embodiment, RSSI-based sensing or CSI-based sensing is performed depending on a currently required standby-power level of the nodes, e.g., lights within the sensing area.

Data processing of RSSI-based sensing requires considerably less processing effort than CSI-based sensing. RSSI consists of a single-byte data point, whereas CSI may contain multiple data points, for example, 64 complex values including real and imaginary part. RSSI directly describes an attenuation of an RF signal. Hence, RSSI is a metric that may be directly indicative of a motion or a presence of a human. In contrast, CSI describes properties of an RF channel as extracted from multiple subcarriers of the RF signal, e.g. WiFi signal. In other words, CSI is not a direct measurement of attenuation of RF signals and hence complex additional processing steps of the measurement data are required before a motion can be inferred based on CSI. RSSI-based sensing may therefore consume less energy compared to CSI-based sensing when the luminaire is in a standby-mode in which its primary function, i.e., providing lighting is not performed. A luminaire for performing CSI-based sensing may require, for example, an iMXRT1060 secondary microcontroller in the luminaire for running the sensing analysis algorithm, while RSSI-based sensing may be performed using an ESP32 microcontroller. The iMXRT1060 microcontroller consumes more energy than the ESP32 microcontroller.

The currently required standby-power level may be provided, for example, based on regulations, e.g., based on a location of the RF system. For example, in California strict standby power requirements are provided for luminaires, specifically whenever the luminaire is in standby-mode, i.e., when light-output is switched off. If the light-output is switched on, the standby power requirements are not applicable. To fulfil the standby power requirements, e.g., of the California energy code (Building Energy Efficiency Standards—Title 24) RSSI-based sensing may be performed when the luminaires light output is off, while performing CSI-based sensing when the light output is switched on, for example, when the sensing area is occupied.

Compared to CSI-based sensing, RSSI-based sensing has a superior SNR as it integrates all multipaths in the channel between the nodes, i.e., the transmitting node and a receiving node. This may allow to further lower the transmit radio power of the luminaire while still maintaining sufficient RSSI-based sensing performance. The lower transmit radio power may, for example, have human health benefits, for instance, in sensing applications in which the transmitting node is located very close to the human, e.g., a node in form of a standing lamp.

In another further embodiment, CSI-based sensing is performed instead of RSSI-based sensing when the wireless network is congested or noisy and hence does not allow for high effective sampling rates between the luminaires.

In yet another further embodiment, the available wireless bandwidth as well as the background noise level may be taken into account when deciding in real time whether to perform CSI-based sensing or RSSI-based sensing in the sensing area.

RSSI-based sensing solely relies on the integral or aggregated RF signal comprised of all wireless multipaths between the nodes. For performing RSSI-based sensing, in this embodiment, the node uses just a single carrier containing a time-series of RSSI data. This RSSI data is processed in an RSSI-based sensing analysis algorithm. On the other hand, a typical CSI data stream may consist of 64 subcarriers.

A CSI-based sensing analysis algorithm may compensate up to a certain degree for a lack of sampling rate imposed by the WiFi network. For example, when an RF message including an expected RSSI sample or CSI sample fails to arrive on time, both the RSSI-based sensing analysis algorithm and the CSI-based sensing analysis algorithm perform a fall-back involving various types of interpolations on the data. The richer data in CSI provides superior references which the CSI-based sensing analysis algorithm may utilize in its interpolation, whereas the simpler nature of the RSSI data makes any interpolation more sensitive to noise present in the RF channel. Although the different multipath components that are extracted from the CSI data stream have lower SNR than for RSSI-based sensing, this may be compensated by CSI metrics providing for the same single received RF message 64 times more values to the sensing algorithm than the RSSI metrics supplies.

Congestion may be accompanied or caused by presence of a continuous wireless background noise. For instance, a noise source, such as a microwave oven or a video-streaming TV may deteriorate the SNR between the nodes performing RF-based sensing and reduce an effective messaging rate between them, e.g., due to an increased number of messages missed by the receiving node.

If the SNR reduction due to the background noise, e.g., wireless interference, is moderate, CSI-based sensing may be preferred over RSSI-based sensing as CSI-based sensing may allow to compensate for the reduced effective messaging rate caused either by missing RF messages at the receiving node or as scheduled RF messages are not successfully transmitted by the transmitting node. If background noise reaches such high levels that the SNR of individual CSI-subcarriers is compromised to such an extent that the CSI-based sensing analysis algorithm fails on a threshold number of subcarriers, CSI-based sensing becomes too error prone and it is preferred to perform RSSI-based sensing.

According to another further embodiment, RSSI-based sensing is performed instead of CSI-based sensing whenever the sensing application is snappy, low-latency motion detection. Compared to CSI, RSSI is a much simpler metric. RSSI is a value that is extracted at the receiving node at the reception of an RF message, regardless of the payload type of the RF message. RSSI is extracted in an identical way from any short or long RF message or even any RSSI-based sensing specific message, e.g., whereby the transmitting node reports to its sensing group its own previously received RSSI data. RSSI can be represented in just a single byte of data. The signed 8 bit representation covers the desired RSSI resolution of +20 dBm to −100 dBm.

While RSSI may use one single byte of data per message, CSI on the other hand may provide about 52 times complex values per RF message to the CSI-based sensing analysis algorithm. CSI-based sensing hence requires a higher amount of processing. This increases latency for motion detection by CSI-based sensing compared to RSSI-based sensing.

Conversely, the simplicity of the RSSI-based metric often makes the RSSI-based sensing analysis algorithm more error prone especially if short detection time windows are targeted, such as 200 ms for occupancy-based lighting control. Within the 200 ms detection time window, there may be too little RSSI data related to event detections available for the RSSI-based sensing analysis algorithm to correlate or confirm detections of sensing events. For example, within the 200 ms time window, in practice only a few RSSI samples may be generated between the nodes. The fewer samples are available, the more the RSSI-based sensing analysis algorithm is impacted if one of the samples within the 200 ms time period is affected by noise. For instance, fewer samples make it harder for the RSSI-based sensing analysis algorithm to determine whether a first sensing link is just being affected by noise instead of human motion, while a second sensing link in the same sensing area experiences effects of human motion.

RSSI-based sensing may therefore be preferred whenever snappy sensing latency is critical, even at the expense of a higher false positive rate. For example, whenever nodes in form of luminaires are presently switched off, i.e., providing no light, a fast response of the RF system is desired to ensure that the luminaires are switched on in less than 200 ms after a person has entered the sensing area.

Whenever the sensing area is presently occupied, e.g., by an office worker, this low latency actuation is not required. In this case CSI-based sensing is preferably performed for generating maximum context awareness as well as minimizing false negatives. For instance, unlike RSSI-based sensing, the CSI-based sensing allows to track breathing motion patterns and hence can reliably perform true presence detection, e.g., of a very still-sitting person watching TV on the couch.

RSSI-based sensing may also be preferred for life-safety-critical sensing applications which require low latency. For instance, RF-based sensing may act as trigger for a secondary alerting system to kick in, for instance to warn workers in a warehouse about an approaching forklift. For these life-safety related application, the risk of missing the sensing event or reacting too late is higher than the dissatisfaction associated with occasional false triggers.

The RF system may be configured to perform vacancy sensing rather than occupancy sensing. For instance, the California energy code (Building Energy Efficiency Standards—Title 24) prescribes vacancy sensing for certain rooms, such as private offices and conference rooms, i.e., lighting has always to be manually switched on by a user via a switch and the lighting must be automatically switched off upon room vacancy. For rooms with vacancy sensing, CSI-based sensing is preferably performed whenever the room is vacant. This allows the RF system to collect detailed insights about the entering persons. For instance, in a conference room, it may already be analysed which person or persons enter the room, while they are entering the room, i.e., while they are in upright body posture before sitting down. The CSI-based sensing may determine a number of persons entering and distinguish between adult and children or may recognize an individual's body shape, e.g. via 60 GHz WiFi. For instance, this information may be used for activating a preferred lighting scene. Once, this information has been obtained, the RF system may perform RSSI-based sensing, e.g., to reduce energy consumption.

In yet another further embodiment, the RF system includes a transmitting node, a CSI-receiving node in form of a luminaire and an RSSI-receiving node in form of a luminaire. Both the CSI-receiving node and the RSSI-receiving node are co-located in the same sensing area and receive the same RF messages transmitted by the transmitting node.

The nodes of the RF system may be, for example, different-generation luminaires. The CSI-receiving node may be, for example, a second-generation luminaire capable of performing CSI-based sensing while the RSSI-receiving node is a first-generation luminaire which is only capable of performing RSSI-based sensing, as its processing power is only sufficient for running an RSSI-based sensing analysis algorithm, but not a CSI-based sensing analysis algorithm. In this embodiment, it is described how RF-based sensing may be performed when a mix of at least one legacy node and at least one newer more capable node is present in the same sensing area.

The transmitting node transmits an RF message, e.g., a WiFi sensing message. The CSI-receiving node receives the RF message and uses it to perform CSI-based sensing, while concurrently the RSSI-receiving node located in the same sensing area receives the same WiFi sensing message, but uses it to perform RSSI-based sensing. In this embodiment, the WiFi sensing message transmitted by the transmitting node is on purpose chosen such that it can be successfully received and processed not only by the Csi-receiving node, but also by the RSSI-receiving node, i.e., the legacy node. For instance, the RSSI-receiving node may only be able to receive 2.4 GHz without OFDM, while the transmitting node and the CSI-receiving node may be capable of also using 5 GHz and OFDM.

It may be advantageous to assign a group or subset-of nodes in a sensing area to perform RSSI-based sensing, either out of bare necessity, e.g., as one of the receiving nodes lacks processing power for perform CSI-based sensing or due to other circumstances, such as having a too low SNR at one of the receiving nodes which does not allow to reliably perform CSI-based sensing.

In case RSSI-based sensing is performed out of bare necessity, the RSSI-receiving node may, for example, comprise an 802.11b WiFi radio, which uses an old and cheap WiFi version which does not utilize OFDM. As the RSSI-receiving node is unable to use subcarriers, it is fundamentally unable to determine CSI. In this case in order to allow the RSSI-receiving node to perform RF-based sensing, the transmitting node also needs to use 802.11b in order to transmit RF messages that can be processed by the RSSI-receiving node.

In case that RSSI-based sensing is performed due to circumstances, for example, the SNR may be compromised due to either a long physical distance between the transmitting node and the RSSI-receiving node or due to a wireless noise source, e.g., a microwave oven, located in proximity to the RSSI-receiving node. As RSSI combines all multipaths, performing RSSI-based sensing in principle allows a superior SNR over performing CSI-based sensing, as each individual multipath extracted by CSI has received only a small portion of the wireless energy emitted by the transmitting node, but a to be detected human body partially interrupting the wireless path still absorbs the same relative 3 dB amount, therefore the useful signal indicative of human presence shrinks.

In summary, three scenarios how a mixture of nodes with different capabilities may perform RF-based sensing based on CSI, RSSI, or a combination thereof may be distinguished.

A first and most likely scenario is that the RSSI-receiving node does not have sufficient processing power, e.g., including a dual microprocessor required for running the CSI-based sensing analysis algorithm. For example, the RSSI-receiving node may include an ESP32 microcontroller. In this case, the RSSI-receiving node is in principle able to extract CSI but is not able to perform CSI-based sensing due to lack of processing power for RF-based sensing event detection. The RSSI-receiving node, therefore, preferably performs RSSI-based sensing.

In a second scenario the RSSI-receiving node has fundamentally insufficient processing capabilities to extract CSI. The RSSI-receiving node may include, for example, an ESP8266 microcontroller. The RSSI-receiving node may nevertheless be capable to understand RF message transmitted by the transmitting node. Also, in this case, the RSSI-receiving node performs RSSI-based sensing and extracts RSSI while a CSI-receiving node performs CSI-based sensing and extracts CSI from the same RF message.

In a third scenario, the transmitting node transmits RF messages which are more complex than what a receiving node may be able to understand or interpret, respectively. The receiving node can neither extract CSI or RSSI. In this case, it is fundamentally impossible to process the same RF messages by a CSI-receiving node and the receiving node as the receiving node cannot process the RF messages.

When transmitting the same RF messages by the transmitting node and performing RSSI-based sensing by the RSSI-receiving node and CSI-based sensing by the CSI-receiving node, an overlap sensing area is formed in proximity to the transmitting node, in which an RSSI sensing area and a CSI sensing area overlap. In further distance to the transmitting node, only either RSSI-based sensing in the RSSI sensing area or CSI-based sensing in the CSI sensing area is performed. In case that the sensing area includes an additional, e.g., a fourth node, which is only capable of performing RSSI-based sensing, the RF system may select whether this fourth node is used for performing RSSI-based sensing or whether the RSSI-receiving node is used for performing RSSI-based sensing. The RF system may be configured for selecting one of these nodes such that a maximal overlap is obtained between the RSSI sensing area and the CSI sensing area, i.e., such that the overlap sensing area is maximized. Furthermore, the overlap sensing area may be selected such that it coincides with an area of interest in which sensing events are expected, e.g., a couch. This may allow the RF system, for example, to analyse a degree of difference between RSSI-based sensing and CSI-based sensing for determining whether properties of the sensing area, such as objects, e.g., furniture, in the overlap sensing area, have changed. This embodiment is also applicable beyond taking care of legacy nodes and may be applicable to all nodes with different capabilities, such as high end nodes with which are capable to perform CSI-based sensing and basic nodes, e.g., lower cost lamps which are only capable of performing RSSI-based sensing. The RF system may include high end nodes and basic nodes.

In another further embodiment, RSSI-based sensing and CSI-based sensing are performed in a sensing area in form of a room. RSSI data obtained from performing RSSI-based sensing and CSI data obtained from performing CSI-based sensing are compared to determine one or more properties, such as an archetype, of the room.

In this embodiment, RF-based sensing is concurrently performed utilizing both RSSI-based sensing which analyses only the aggregated multi-path RF signal and CSI-based sensing which analyses at individual multipath level to estimate the properties of the room, e.g., a shape, an archetype, a regularity, material types of the room or other properties of the room. A degree of difference between RSSI data and CSI data including RSSI sensing results and CSI sensing results is analysed to determine, e.g., by inferring, the properties of the room. For example, if the time-series of RSSI and CSI are quite similar in terms of variations that the RF signals suffer with and without human presence, this means that the multipath behaviour within the sensing area is quite limited, indicating that the room might be very large and empty. If lots of differences are observed between the RSSI sensing results and CSI sensing results, it implies that a first group or subset of multipaths is dominant over the remaining second subset of multipaths.

Archetypes of rooms may include predetermined classifications, e.g., for open space, e.g., open plan office, compact space, e.g., a private office surrounded by walls, half-open space, e.g., open kitchen-living room, and rooms containing many load-bearing walls, e.g., indicating that the room is located at a corner of a building.

In a further embodiment, RSSI-based sensing is performed during certain growth stages of a horticulture plant. The RSSI-based sensing may be performed for monitoring the growth and/or the RF-based sensing may be performed taking into account a current growth stage of the horticulture plant.

RSSI-based sensing allows transmitting RF signals with a lower transmit radio power while still maintaining a sufficient RSSI-based sensing performance as it may have a superior SNR since it integrates all multipaths in the channel between the nodes. The lower transmit radio power may yield plant health benefits, for instance, in applications in which the transmitting node, e.g., transmitting luminaire is located very close to the plants, such as for a vertical farming horticulture luminaire.

The RF-based sensing may be utilized for monitoring the plant growth. It may be advantageous at certain growth stages of the plant to minimize its RF exposure caused by the nodes performing RF-based sensing. For instance, for a soybean plant RSSI-based sensing is preferred during the seedling stage to minimize RF exposure, while at later growth stages, which are less affected by wireless radiation, CSI-based sensing may be performed for providing more detailed sensing data than RSSI. It may also be preferable for selecting the location of a receiving node in proximity to the plant instead of as transmitting node. Furthermore, RSSI-based sensing may be performed by nodes in proximity to the plant.

FIG. 4 shows an embodiment of a method 400 for performing RF-based sensing in a sensing area by two nodes. The nodes may be, for example, nodes of an RF system, such as the CL system 100 or CL system 100′ presented in FIG. 2 and FIG. 3, respectively.

In step 402, a current context is determined for performing RF-based sensing. The current context may include factors such as a sensing application, a latency requirement, a radio power consumption requirement, a radio transmit power requirement, a radio beam shape requirement, a radio receive beamforming requirement, a current location of the RF system, a current location of one or more of the nodes, such as their relative locations to each other, a current date, such as a day of the week and/or time of the day, a current operation mode of the at least one of the nodes, such as stand-by mode, environmental effects, such as wireless interference, currently available bandwidth in the RF system, current capabilities of one or more of the nodes, current properties of the sensing area, and a false event detection rate requirement, In other embodiments, the current context may also include further factors, such as a growth stage of a plant in the sensing area. The factors may be determined in different ways, e.g., a sensing application may be determined based on a selection, which sensing application is to be performed by the nodes. Other factors, such as a current data may be determined based on a calendar. The current location may be determined, for example, based on global positioning system (GPS) and/or other methods for determining the current location, such as determining a distance between the nodes for determining a relative location of the nodes based on time-of-flight (TOF) measurements.

In step 404, one of the nodes is configured for performing RF-based sensing based on CSI, RSSI, or a combination thereof based on the current context, i.e., it is selected whether the node performs RF-based sensing based on CSI, RSSI, or a combination thereof, such as interleaving CSI and RSSI for different time intervals. The factors of the current context are weighted according to a CSI-RSSI-selection algorithm. The CSI-RSSI-selection algorithm may be a rule-based algorithm, a machine learning algorithm, or any other type of algorithm that allows selecting CSI, RSSI, or a combination thereof for performing RF-based sensing based on the current context. Since the current context is determined in real time, the node may be configured in real time to adapt to the current situation and optimize the RF-based sensing for the current situation.

In step 406, RF-based sensing is performed. Depending on how the node is configured in step 404, RF-based sensing is performed based on CSI, RSSI, or a combination thereof, i.e., concurrently performing RF-based sensing based on CSI and RSSI. This allows to improve detection performance and/or to reduce energy consumption.

In step 408, an action is performed in response to detecting a sensing event by performing RF-based sensing. For example, if the sensing area is a room and a sensing event to be detected by the RF-based sensing is occupancy of the room, the action may be turning on lighting if occupancy of the room is detected. In other embodiments, other actions may be performed in response to detecting a sensing event, such as providing a warning or alarm signal.

In step 410, one or more properties of the sensing area are determined based on performing CSI-based sensing and RSSI-based sensing. In this embodiment, the properties of the sensing area are determined based on differences in the CSI data and RSSI data obtained by concurrently performing CSI-based sensing and RSSI-based sensing. Step 410 is optional.

In other embodiments, more than two nodes may be used for performing RF-based sensing, e.g., three nodes. In this case, for example, a transmitting node may transmit the same RF messages to a CSI-receiving node for performing CSI-based sensing and an RSSI-receiving node for performing RSSI-based sensing. The transmitting node may furthermore also receive the same RF messages it transmitted for performing RF-based sensing. This may allow performing RF-based Doppler sensing.

CSI-based sensing may be performed in a CSI sensing area. The CSI sensing area may be included in the sensing area. RSSI-based sensing may be performed in an RSSI sensing area. The RSSI sensing area may be included in the sensing area. It may be provided that at least part of the CSI sensing area overlaps with the RSSI sensing area in an overlap sensing area. Furthermore, it may be provided that the overlap sensing area is maximized, e.g., based on selecting nodes or locations of nodes for performing RF-based sensing. It may also be provided that an area of interest is within the overlap area.

In yet other embodiments, RF-based sensing may be performed for monitoring growth of a plant.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein the RF system is a heating ventilating air-conditioning (HVAC) system, a smart home system, or any other type of RF system.

Other variations to the disclosed embodiments can be understood and effected by those skilled in the art in practicing the claimed invention, from a study of the drawings, the disclosure, and the appended claims.

In the claims, the word “comprising” and “including” does not exclude other elements or steps, and the indefinite article “a” or “an” does not exclude a plurality.

A single unit, processor, or device may fulfill the functions of several items recited in the claims. The mere fact that certain measures are recited in mutually different dependent claims does not indicate that a combination of these measures cannot be used to advantage.

Operations like determining a current context for performing RF-based sensing, configuring at least one of the nodes for performing RF-based sensing based on CSI, RSSI, or a combination thereof based on the current context, performing RF-based sensing based on CSI, RSSI, or a combination thereof based on the current context, concurrently performing RF-based sensing based on CSI and RSSI, et cetera performed by one or several units or devices can be performed by any other number of units or devices. These operations and/or the method can be implemented as program code means of a computer program and/or as dedicated hardware.

A computer program product may be stored/distributed on a suitable medium, such as an optical storage medium, or a solid-state medium, supplied together with or as part of other hardware, but may also be distributed in other forms, such as via the Internet, Ethernet, or other wired or wireless telecommunication systems.

Any reference signs in the claims should not be construed as limiting the scope.

The present invention relates to performing RF-based sensing based on CSI, RSSI, or a combination thereof based on a current context. A current context for performing RF-based sensing is determined and at least one of two nodes of an RF system is configured for performing RF-based sensing based on CSI, RSSI, or a combination thereof based on the current context. The current context may be determined in real time. This may allow improving detection performance and/or reducing energy consumption in real time.

1. A radio frequency system comprising at least two nodes for performing radio frequency based sensing in a sensing area, wherein the radio frequency system is configured for determining a current context for performing radio frequency based sensing and for configuring at least one of the nodes for performing radio frequency based sensing, wherein the configuring the at least one of the nodes comprises selecting whether the node performs radio frequency based sensing based on:
channel state information,
received signal strength indicator, or
a combination thereof;
based on the current context.

2. The radio frequency system according to claim 1, wherein the current context includes one or more of:
a sensing application,
a latency requirement,
a radio power consumption requirement,
a radio transmit power requirement,
a radio beam shape requirement,
a radio receive beamforming requirement,
a current location of the radio frequency system,
a current location of the at least one of the nodes,
a current date,
a current operation mode of the at least one of the nodes,
environmental effects,
currently available bandwidth in the radio frequency system,
current capabilities of the at least one of the nodes,
current properties of the sensing area,
a false event detection rate requirement, and
a growth stage of a plant in the sensing area.

3. The radio frequency system according to claim 1, wherein the radio frequency system is configured for concurrently performing radio frequency based sensing based on channel state information and received signal strength indicator.

4. The radio frequency system according to claim 1, wherein the at least two nodes include:
a transmitting node,
a channel state information receiving node for performing radio frequency based sensing based on channel state information, and
a received signal strength indicator receiving node for performing radio frequency based sensing based on received signal strength indicator.

5. The radio frequency system according to claim 4, wherein the transmitting node is configured for transmitting same radio frequency messages to the channel state information receiving node and the received signal strength indicator receiving node for performing radio frequency based sensing.

6. The radio frequency system according to claim 5, wherein the transmitting node is configured for transmitting and receiving the same radio frequency messages transmitted to the channel state information receiving node and the received signal strength indicator receiving node for performing radio frequency based sensing by the transmitting node.

7. The radio frequency system according to claim 4, wherein the channel state information receiving node is configured for performing radio frequency based sensing based on channel state information in a channel state information sensing area, wherein the received signal strength indicator receiving node is configured for performing radio frequency based sensing based on received signal strength indicator in a received signal strength indicator sensing area, wherein the channel state information sensing area and the received signal strength indicator sensing area are included in the sensing area, and wherein at least part of the channel state information sensing area overlaps with the received signal strength indicator sensing area in an overlap sensing area.

8. The radio frequency system according to claim 7, wherein the received signal strength indicator receiving node is selected from the at least two nodes for performing radio frequency based sensing in the sensing area, the channel state information receiving node is selected from the at least two nodes for performing radio frequency based sensing in the sensing area, or the received signal strength indicator receiving node and the channel state information receiving node are selected from the at least two nodes for performing radio frequency based sensing in the sensing area such that the overlap sensing area is maximized and/or an area of interest is within the overlap area.

9. The radio frequency system according to claim 1, wherein the radio frequency system is configured for determining one or more properties of the sensing area based on performing radio frequency based sensing based on received signal strength indicator and/or channel state information.

10. The radio frequency system according to claim 1, wherein the radio frequency system is configured for performing radio frequency based sensing for monitoring growth of a plant.

11. The radio frequency system according to claim 1, wherein at least two of the nodes have different capabilities.

12. A method for performing radio frequency based sensing in a sensing area by at least two nodes, including the steps:
determining a current context for performing radio frequency based sensing, and
configuring at least one of the nodes for performing radio frequency based sensing, wherein the configuring the at least one of the nodes comprises selecting whether the node performs radio frequency based sensing based on:
channel state information,
received signal strength indicator, or
a combination thereof;
based on the current context.

13. The method according to claim 12, wherein the method includes one or more of the steps:
concurrently performing radio frequency based sensing based on channel state information and received signal strength indicator,
transmitting by a transmitting node same radio frequency messages to a channel state information receiving node for performing radio frequency based sensing based on channel state information and a received signal strength indicator receiving node for performing radio frequency based sensing based on received signal strength indicator,
transmitting and receiving by the transmitting node the same radio frequency messages transmitted to the channel state information receiving node and the received signal strength indicator receiving node for performing radio frequency based sensing by the transmitting node,
performing radio frequency based sensing in a channel state information sensing area, wherein the channel state information sensing area is included in the sensing area,
performing radio frequency based sensing in a received signal strength indicator sensing area, wherein the received signal strength indicator sensing area is included in the sensing area,
providing that at least part of the channel state information sensing area overlaps with the received signal strength indicator sensing area in an overlap sensing area,
providing that the overlap sensing area is maximized,
providing that an area of interest is within the overlap area,
determining one or more properties of the sensing area based on performing radio frequency based sensing based on received signal strength indicator and/or channel state information, and
performing radio frequency based sensing for monitoring growth of a plant.

14. A computer program product for performing radio frequency based sensing in a sensing area by at least two nodes, wherein the computer program product comprises program code means for causing a processor to carry out the method according to claim 12, when the computer program product is run on the processor.

15. A computer readable medium having stored the computer program product of claim 14.
